(19) United States
(12) Patent Application Publication
(10) Pub. No.: US 2006/0019115 A1
(43) Pub. Date: Jan. 26, 2006

(54) Composite material having improved microstructure and method for its fabrication

(76) Inventors: Liya Wang, Ann Arbor, MI (US); Michael Heath, Allen Park, MI (US); John Miller, Eugene, OR (US); Michael Wixom, Ann Arbor, MI (US); Suresh Mani, Ann Arbor, MI (US)

Correspondence Address: Ronald W. Citkowski;Gifford, Krass, Groh, Sprinkle,, Anderson & Citkowski, P.C., P.O. Box 7021, Troy, MI, 48007-7021, US

(21) Appl. No.: 11/133,054

(22) Filed: May 19, 2005

Related U.S. Application Data
(60) Provisional application No. 60/572,710, filed on May 20, 2004.

(51) Int. Cl. H01M 4/86

(52) U.S. Cl. 428/570; 429/44

(57) ABSTRACT

A composite material which may be used as an electrode for a battery or other electrochemical device, or as a catalyst, has a matrix which is one or more metal carbide, metal nitride, metal boride, metal silicide or intermetallic compound. A metallic component is dispersed in the matrix. The metallic component comprises a metal and an agent which increases the melting point of the metal. The metallic component may be nanodispersed in the matrix. A specific material comprises a nanodispersion of tin, alloyed with an element which increases its melting point to at least 600° C., disposed in a matrix of a transition metal carbide or nitride. This material has very good utility as an anode material for lithium batteries. Also disclosed are other compositions as well as methods for manufacturing the compositions.

### RELATED APPLICATION

This application claims priority of U.S. Provisional Patent Application Ser. No. 60/572,710 filed May 20, 2004, entitled “Composite Material Having Improved Microstructure and Method for Its Fabrication” which is incorporated herein by reference.

### FIELD OF THE INVENTION

This invention relates generally to composite material. More specifically, the invention relates to composite materials comprised of a metallic component dispersed in a matrix. Most specifically, the invention relates to a composite material comprising a metallic component which is nanodispersed in an electrically conductive matrix.

### BACKGROUND OF THE INVENTION

Composite materials of the particular type comprising a metal dispersed in a matrix, preferably an electrically conductive matrix, are of growing importance. Such materials have found utility as electrodes for batteries and other electrochemical systems, and as catalysts. In one specific instance, such materials have utility as anodes for lithium batteries. In many instances, preferred metals for use in these composites comprise relatively low melting metals such as group III-V metals, specifically including tin, indium, gallium, thallium, lead, bismuth, and antimony.

In many instances, the metal is present in the matrix material in the form of a nanodispersion. Typically, a nanodispersed material comprises regions having a size of no more than 1000 angstroms. In many embodiments, the regions have a size in the range of 200 to 500 angstroms. The low melting point of many of the preferred materials presents problems when nanodispersed composites are being prepared or fabricated into finished shapes.

Nanocomposites of metals dispersed in an electrically conductive matrix material are, as noted above, of interest as anode materials for lithium batteries. One such group of materials comprises a relatively low melting metal such as tin dispersed in a transition metal nitride, boride, silicide or oxide matrix, such as a VC matrix. One of the major technical difficulties in obtaining a proper nanodispersion of a metal such as tin in a metal carbide or metal nitride host matrix is due to the low melting temperature of tin. Tin has a melting point of approximately 232° C., and the use of processing techniques such as temperature programmed reactions (TPR) and high impact ball milling involve temperatures above the melting point of tin. Therefore, tin could be present in a liquid state during processing. As a result, large tin spheres are easily formed through aggregation during TPR processing, and large tin flakes are formed during high impact ball milling. The existence of large tin particles severely limits the cycle life of tin-based anode materials as a result of breakup of these large particles during cycling which occurs during charge and discharge of batteries incorporating the electrode. Such breakup results in mechanical degradation of the electrodes.

The present invention provides metal-based nanocomposites having an improved and stabilized microstructure. Use of the nanocomposite materials of the present invention stabilizes the performance characteristics of batteries and other electrochemical devices which incorporate these materials. Furthermore, the methods and materials of the present invention remove constraints which have heretofore restricted the processing options used for the preparation of such materials. As will be apparent from the discussion and description below, the present invention allows for the production of stabilized nanocomposite materials which in turn allow for the manufacture of stable, efficient catalysts, batteries and other electrochemical devices.

### BRIEF DESCRIPTION OF THE INVENTION

Disclosed is a composite material comprised of a matrix material selected from the group consisting of metal carbides, metal nitrides, metal borides, metal silicides, intermetallic compounds and combinations thereof; and a metallic component dispersed in said matrix, said metallic component comprising a metal and an agent which raises the melting point of said metal. In particular instances, the metal initially has a melting point below 600° C. and the agent is present in an amount sufficient to raise the melting point of the metal to a temperature greater than 600° C. The agent may, in some instances, form an alloy or an intermetallic compound with the metal.

In a particular instance, the metallic component comprises an alloy of tin and one or more of calcium, zirconium and barium. In particular instances, the matrix material comprises a metal carbide or metal nitride, and vanadium carbide and vanadium nitride are specific examples thereof.

The metallic component may be nanodispersed in the matrix material, and in particular instances has a particle size in the range of 5-50 nanometers, and in particular instances a size of no more than 20 nanometers, as measured by x-ray diffraction. Also disclosed herein are electrodes for electrochemical devices which electrodes incorporate the composite materials of the present invention. Specifically disclosed is an electrode for a lithium battery. This electrode is comprised of a matrix material selected from the group consisting of metal carbides, metal nitrides, metal borides, metal silicides, intermetallic compounds and combinations thereof. A metallic component is dispersed in the matrix, and this metallic component comprises tin and an agent which raises the melting point of the tin to a temperature of at least 600° C. Also disclosed herein are methods for making the materials.

### BRIEF DESCRIPTION OF THE DRAWINGS

FIG. 1 is a graph comparing the charge/discharge voltage profiles of a prior art VC/Sn composite electrode material, and a VC/Sn/Zr composite material of the present invention; and

FIG. 2 is a graph comparing the cycling performance of the prior art VC/Sn composite with the VC/Sn/Zr composite of the present invention.

### DETAILED DESCRIPTION OF THE INVENTION

In accord with the present invention, there are provided methods and means whereby composite materials having nanodispersions of metals, which are normally low melting metals, may be prepared. As described above, the metals used in the practice of the present invention typically comprise group III-V metals such as tin, indium, gallium, thallium, lead, bismuth and antimony. The metals may be used singly or in combination. Tin is one particularly important metal used in the manufacture of such composites because it demonstrates superior electronic properties as a material for battery electrodes.

The matrix materials used in the present invention most preferably comprise electrically conductive materials which, in some instances, are electrochemically inert. One class of matrix materials comprises borides, nitrides, carbides, silicides and oxides of one or more metals taken either singly or in combination, and these metals are most preferably transition metals. One specific group of materials in this class comprises compounds of vanadium. Another specific class of matrix materials comprises intermetallic compounds; and as is understood in the art, intermetallic compounds comprise alloys or other compounds of one or more metals which may form specific multi-metallic compounds or solid solutions of varying compositions which may be stoichiometric or non-stoichiometric.

In a first aspect of the present invention, the metal component of the composite includes an agent which functions to raise its melting point above the normal melting point of the metal. This agent is referred to herein as an alloying agent, although it is to be understood that it need not function to form a true stoichiometric alloy, and in some instances forms an off stoichiometry alloy such as an intermetallic material. Generally, the alloying agent raises the melting point of the metal to a temperature greater than that which will be encountered during processing and/or use of the composite. In specific instances this temperature will be at least 600° C. The identity of the alloying agent will depend upon the specific metal employed to form the composite. In the instance where the metal of the composite is tin, some specifically preferred alloying agents include zirconium, calcium and barium. Typically, the alloying agent is a minor component of the metallic compound so as to allow the advantageous properties of the metal to be asserted in the composite. However, the alloying agent of the present invention is to be distinguished from dopants, which are used in amounts too low to advantageously raise the melting point of the metal, even though the alloying agents of the present invention may be the same as certain dopants. For example, calcium may be alloyed with tin to form the compound CaSn₃. This compound has a melting point of 627° C. In a similar manner, zirconium can be alloyed with tin to form the compound ZrSn₂, which has a melting point of approximately 1140° C. Still other alloying agents will be apparent to one of skill in the art.

In a second aspect of the present invention, problems of metallic agglomeration, and resultant loss of microstructure, can be overcome by controlling the surface tension between the metal and the matrix material. If the surface tension is lowered, the metal, even if molten, will wet and adhere to the host matrix and thereby not agglomerate. In this regard, it has been found that the presence of one or more of vanadium, molybdenum, tantalum, niobium, and/or rhodium in the host material will promote wetting of the host by molten tin. The wetting agents can be directly incorporated into the bulk of the host material, as for example by alloying or the like during the fabrication of the host material; alternatively, the host material may comprise particles of bulk material coated with the wetting agent. For example, a powdered host material such as VC can have at least a portion of its surface covered by a wetting agent. This coating can be applied by a number of processes such as chemical vapor deposition, plasma coating or the like. In some instances, the coating may be deposited by coating a precursor material, such as an organometallic compound, a metal salt or the like, onto particles of the host material, and then reducing the compound to form a layer of the metallic wetting agent. It is also to be understood that other coatings may be similarly employed for this purpose, and the composition and nature of these coatings will depend upon the identity of the matrix and the metal compound. One of skill in the art can readily select appropriate wetting agents.

Surface tension can also be controlled by adding a chemical wetting agent to the metallic compound itself. This wetting agent functions to lower the surface tension of the molten metal, with regard to the host matrix, and thereby prevents agglomeration and loss of microstructure. The specific identity of this chemical wetting agent will depend upon the metal, as well as the host matrix. In the instance where the metal comprises tin, or a tin alloy, some preferred wetting agents have been found to be titanium, zirconium, nickel, iron, silicon and aluminum. Typically, these wetting agents are present in a relatively small amount, and generally comprise a minor component of the metallic material. It will be noted that, with regard to tin, there is some overlap in the chemical wetting agents and the alloying agents for raising the melting point. Specifically, zirconium has been found to have utility in both aspects of this invention. In that regard, relatively small amounts of zirconium are beneficial in tin materials, since they promote wetting of matrix materials; while relatively larger amounts of zirconium function to raise the melting point of tin.

The composite materials of the present invention may be prepared utilizing one or more of the various aspects of the present invention. For example, a nanostructured composite can be prepared utilizing an alloying agent to raise the melting point of the metallic component and further utilizing a chemical wetting agent to increase the wetting of the matrix by the metallic component. Likewise, the matrix material can also include a coating for reducing surface tension between it and the metallic component. The specific combination of techniques and materials will depend upon the nature of the metallic component, the nature of the matrix material, as well as conditions which are likely to be encountered during the manufacture, processing and use of the resultant component.

One very important class of nanocomposite materials of the present invention comprise nanodispersions of a tin-based metallic material in an electrically conductive host matrix of transition metal carbides, nitrides, borides and/or silicides. These materials have demonstrated significant utility as electrodes for batteries; and in particular, rechargeable lithium batteries. As noted above, the relatively low melting point of tin (approximately 232° C.) poses significant problems in the fabrication and use of these tin-based materials. In accord with the present invention, a number of tin-based nanocomposite materials have been prepared, and their performance evaluated in the context of lithium ion electrochemical cells.

In a first experimental series, nanocomposite materials comprising a Sn—Ca metallic phase dispersed in a VC matrix were prepared using high impact ball milling. In one group of experiments, a series of samples were prepared from a powder mixture comprising Sn:Ca:VC in a 3:1:4 stoichiometric (atomic) ratio. The mixtures were loaded into hardened steel vials via a dry box and milled for periods of time ranging from a few hours to tens of hours. The materials were then recovered in the dry box and analyzed by x-ray diffraction to identify the phase constitution and crystallite size. Comparison samples were prepared incorporating no calcium, in accord with the prior art utilizing an identical procedure. It was found that the addition of calcium effectively reduces the crystallite size of the tin phase in the material. Without calcium, the crystallite sizes of tin in high impact ball milled materials was found to be approximately 25 nm. Adding calcium to the mixture further reduces the crystallite size to approximately 15 nm. Electrochemical performance of the calcium-containing materials is excellent.

In a second series of experiments, a group of materials comprising alloys of tin and zirconium dispersed in a VC matrix were prepared by a high impact ball milling procedure. In this group of experiments, a powder mixture of Sn:Zr:VC in stoichiometric (atomic) ratios of 2:1:3 and 2:1:4.5 were prepared. The ball milling was carried out as in the previous experimental series, and in that regard, the mixtures were loaded into hardened steel vials via a dry box and milled for periods of time ranging from a few hours to tens of hours. The materials were then recovered in the dry box and analyzed by x-ray diffraction to identify the phase constitution and crystallite size. Thereafter, the materials were incorporated into lithium battery cells and their electrochemical properties were evaluated. With regard to the zirconium-containing materials, it was found that the presence of zirconium caused the formation of metallic domains of approximately 15 nm in diameter whereas zirconium-free control samples prepared under identical conditions had a metallic domain size of approximately 25 nm.

It was further found that the addition of zirconium significantly changes the voltage profile of tin-based anode materials. In determining the voltage profile, test cells incorporating the various anode materials were prepared according to standard procedures. Specifically, the anode materials were slurried with carbon black (Super P obtained from Timcal of Belgium) together with a binder solution comprised of 5% polyvinylidenedifluoride (PVDF) in n-methyl pyrrolidone (NMP). The slurry formulation was, on a weight percent basis, 80% of the active anode material, 8% carbon, and 12% PVDF binder. The slurry was then cast onto a sheet of copper foil with a doctor blade and vacuum dried for eight hours at approximately 110° C. The coated copper foil was cut into electrodes and assembled into cells. In this regard, each cell included the anode, a cell separator (Celgard 2325), an electrolyte (typically 1 M LiPF₆ in 1:1:1:propylene carbonate:ethylene carbonate:ethyl-methyl carbonate) with a counter electrode of metallic lithium pressed onto a metallic copper current collector. The electrode stack was placed into a pouch container (ShieldPack class PPD material).

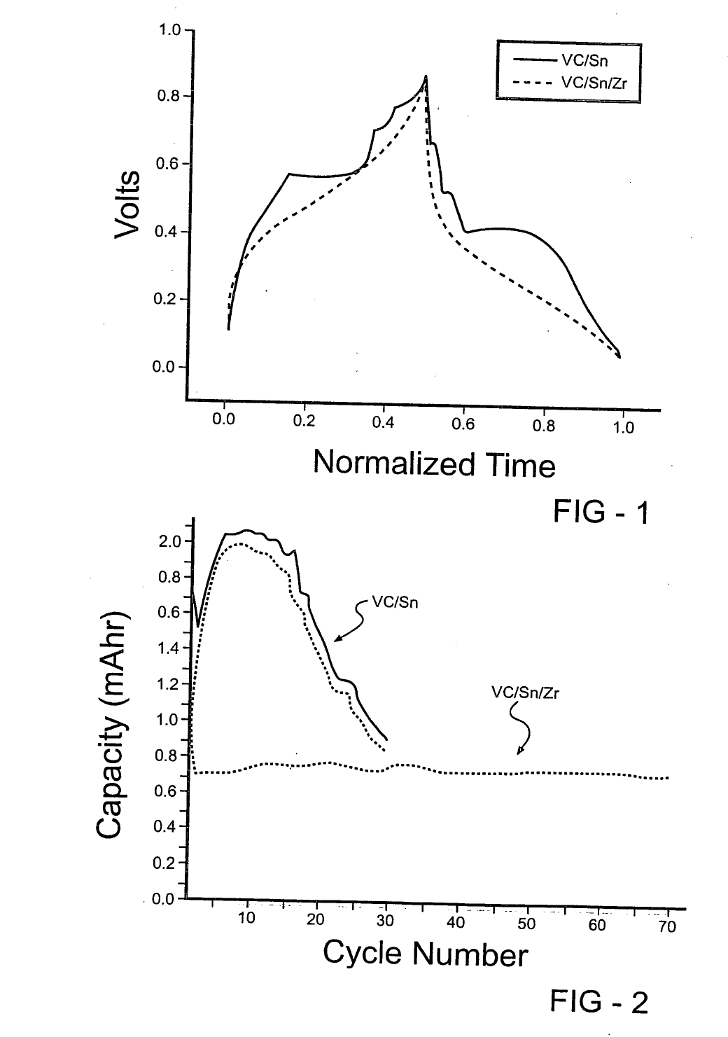

The thus-prepared cells were tested on a Maccor Series 4000 battery tester and cycled through charge and discharge modes. To generate the data of FIG. 1, cells were charged and discharged over a four-hour cycle which is represented by the axis labeled “normalized time.” During charge and discharge, the voltage was measured, and measured voltage is indicated along the axis labeled “volts.” FIG. 1 shows the charge/discharge profiles for a prior art VC/Sn material and a VC/Sn/Zr material of the present invention. As will be seen from FIG. 1, the prior art material exhibits several plateaus in its charge and discharge profile. It is believed that these plateaus are indicative of phase transitions taking place in the material. It is believed that these phase transitions are a contributing factor to the degradation of the material in use. In contrast, the material of the present invention exhibits a smooth charge/discharge profile.

FIG. 2 shows the capacity of the prior art VC/Sn and VC/Sn/Zr of the present invention, in terms of milliamps per hour as a function of the number of charge/discharge cycles. In generating this data, the cells were charged and discharged at a two-hour cycle rate. As will be seen, the prior art VC/Sn material shows significant changes in capacity over a run of thirty cycles. The material initially increases in capacity and then decreases. It is presumed that this is due to mechanical degradation of the material. It is also notable that there is a gap between the charge and discharge curves for the prior art material. This indicates a differential between the capacity as measured when the cell is charged and when it is discharged. This gap represents a loss in stored charge, and as such, the prior art material shows a Coulomb efficiency of approximately 95%. In contrast, the VC/Sn/Zr material of the present invention shows a very flat and uniform capacity over a range of seventy cycles. Furthermore, there is no real separation between the charge and discharge values. As such, the Coulomb efficiency of the material of the present invention is over 99.5%.

In the FIG. 2 graph, the capacity of the prior art material is shown as being greater, in all instances, than that of the material of the present invention. This discrepancy does not indicate any inherent inefficiency in the present material; but, is an artifact of the experiment indicative of the fact that the battery cell incorporating the prior art material included more anode material, and hence an inherently greater capacity, than the cell utilizing the material of the present invention.

The foregoing results illustrate that the material of the present invention provides improved stability and performance as compared to prior art materials. Similar improvements resultant from the use of additives other than the specific compositions described herein are likewise anticipated.

As will be seen from the foregoing, use of alloying agents in accord with the present invention significantly improves the cycle life of the tin-based anode material, and this improvement translates into improved battery life and performance in cells incorporating the materials of the present invention.

The disclosure, discussion, description and examples presented herein are illustrative of specific embodiments of the present invention, but are not meant to be limitations upon the practice thereof. Other embodiments, modifications and variations of the present invention will be apparent to one of skill in the art, in view of the disclosure hereof. It is the following claims, including all equivalents, which define the scope of the invention.

1. A composite material comprising:
a matrix material selected from the group consisting of: metal carbides, metal nitrides, metal borides, metal suicides, intermetallic compounds, and combinations thereof; and
a metallic component dispersed in said matrix, said metallic component comprising a metal and an agent which raises the melting point of said metal.

2. The composite material of claim 1, wherein said metal initially has a melting point below 600° C. and said agent is present in an amount sufficient to raise the melting point of said metal to a temperature greater than 600° C.

3. The composite material of claim 1, wherein said agent forms an alloy with said metal.

4. The composite material of claim 1, wherein said agent forms an intermetallic compound with said metal.

5. The composite material of claim 1, wherein said metallic component comprises an alloy of tin and one or more of calcium, zirconium and barium.

6. The composite material of claim 5, wherein said metallic component comprises CaSn₃.

7. The composite material of claim 5, wherein said metallic component comprises ZrSn₂.

8. The composite material of claim 1, wherein said matrix material comprises a metal carbide or a metal nitride.

9. The composite material of claim 1, wherein said matrix material comprises vanadium carbide.

10. The composite material of claim 1, wherein said metallic component is nanodispersed in said matrix material.

11. The composite material of claim 1, wherein said metallic component has a particle size in the range of 5 to 50 nanometers.

12. The composite material of claim 1, wherein said metallic component has a particle size of no more than 20 nanometers.

13. An electrode for a lithium battery, said electrode comprising:
a matrix material selected from the group consisting of: metal carbides, metal nitrides, metal borides, metal silicides, intermetallic compounds, and combinations thereof; and
a metallic component dispersed in said matrix, said metallic component comprising tin and an agent which raises the melting point of said tin to a temperature of at least 600° C.

14. The electrode of claim 13, wherein said metallic component is nanodispersed in said matrix.

15. The electrode of claim 14, wherein said metallic component has a particle size in the range of 5 to 50 nanometers.

16. The electrode of claim 14, wherein said metallic component has a particle size of no more than 20 nanometers.

17. The electrode of claim 13, wherein said agent is selected from the group consisting of: Ca, Zr, Ba, and combinations thereof.

18. The electrode of claim 13, wherein said matrix comprises VC.

19. A lithium battery which includes the electrode of claim 13.
